(19) United States
(12) Patent Application Publication
(10) Pub. No.: US 2018/0102538 A1
(43) Pub. Date: Apr. 12, 2018

(54) Copper Vanadium Oxides as a Reversible Cathode for Lithium Ion Batteries

(71) Applicant: Brookhaven Science Associates, LLC, Upton, NY (US)

(72) Inventors: Feng Wang, Mount Sinai, NY (US); Xiaoya Wang, Vestal, NY (US); Peter G. Khalifah, Setauket, NY (US); Jason Graetz, Calabasas, CA (US)

(21) Appl. No.: 15/726,942

(22) Filed: Oct. 6, 2017

Related U.S. Application Data
(60) Provisional application No. 62/405,664, filed on Oct. 7, 2016.

(51) Int. Cl. H01M 4/485; C01G 3/02; C01G 31/02

(52) U.S. Cl. CPC H01M 4/485; H01M 2004/028; C01G 31/02; C01G 3/02

(57) ABSTRACT

A lithium ion battery having a cathode including an α-copper vanadium oxide having a stoichiometry of Cu₇₋ₓV₆O_{19-X}, wherein 0≤x≤0.5, and a discharge capacity of at least 250 mAh/g after 20 cycles is claimed. Solid state and hydrothermal reaction methods of synthesizing the α-copper vanadium oxide are also claimed.

### CROSS REFERENCE TO RELATED APPLICATION

The present application claims the benefit of U.S. Provisional Application Ser. No. 62/405,664, filed on Oct. 7, 2016, the contents of which are hereby incorporated by reference in its entirety.

### STATEMENT OF GOVERNMENT LICENSE RIGHTS

The present invention was made with government support under contract numbers DE-AC02-98CH10886 and DE-SC0012704 awarded by the U.S. Department of Energy. The United States government may have certain rights in this invention.

### BACKGROUND

Lithium ion batteries (LIBs) are based on intercalation reaction mechanisms. The lithium intercalation and de-intercalation may occur during discharge and charge process. For the intercalation mechanism using for example LiCoO₂ or LiFePO₄, there may be one (1) electron transfer occurrence per one transition metal (e.g., 3d transition metal). In other words, one electron may be transferred by one redox center.

### SUMMARY

In the present disclosure, multiple electron redox reactions may be utilized for reversible or rechargeable LIBs. In one embodiment Cu—V—O systems may allow multiple electrons to be transferred during an electrochemical process. A copper displacement reaction may allow for a transfer of two (2) electrons (e⁻) during an electrochemical cycle. Thus, the Cu—V—O system may deliver a higher capacity for a lithium ion battery due to its higher gravimetric capacity and energy density than other vanadium oxides (e.g., Ag—V—O). An energy density of up to 850 Wh/kg, specific capacity of up to at least 350 mAh/g and working potentials (above 2.4 V) may be achieved.

The present α-phase of Cu—V—O may have a crystal structure in space group R-3 (No. 148) and lattice parameters of a=12.8560 Å and c=7.1939 Å when x=0.1. This phase herein may be referred to as α-CVO. α-CVO has been reported to have a variable composition of Cu₇₋ₓV₆O₁₉₋ₓ where 0≤x<0.5, due to the presence of two different redox-active cations and due to the difficulty of probing oxygen vacancies using X-ray diffraction techniques.

Based on the results of structural analysis, the present α-CVO may be used as a cathode. The present cathode with α-CVO may be used in rechargeable lithium ion battery systems. The present α-CVO may have “wide” open channels for Cu-ion and Li-ion transport, where vanadium ions are clusters that are separated from each other by intervening Cu and/or Li ions. The present α-CVO may result in displacement reaction chemistry where one divalent Cu cation may be replaced by two monovalent Li cations.

The invention relates to a lithium ion battery having a cathode including an α-copper vanadium oxide with a stoichiometry of Cu₇₋ₓV₆O_{19-X}, wherein 0≤x≤0.5, and the discharge capacity is at least 250 mAh/g after 20 cycles. Preferably, the discharge capacity is at least 289 mAh/g after 20 cycles.

The battery may have an energy density of between 650 and 850 Wh/kg or an energy density of up to about 850 Wh/kg.

The copper vanadium oxide has open channels for lithium ion transfer during an electrochemical cycling process.

The invention also relates to solid state method of making a cathode material of an alpha phase of copper vanadium oxide comprising grinding a copper oxide precursor and a vanadium oxide precursor to form a powder mixture, pressing the powder mixture to form a first pellet, and heating the first (i.e., pristine) pellet under inert gas at a temperature of at least about 250° C., cooling the first pellet to room temperature, ball milling the first pellet to form a milled pellet, pressing the milled pellet to form a second (i.e., solid) pellet, heating the second pellet under inert gas at a temperature of at most about 495° C., and cooling the solid pellet to room temperature to form the cathode material. Preferably, the cathode material is composed of nanoparticles and the inert gas is argon. In one embodiment, the solid state method may further include assembling the cathode material into a coin cell. Preferably, the copper oxide precursor is Cu₂O and the vanadium oxide precursor is V₂O₅. Most preferably, the cathode material is Cu₇₋ₓV₆O_{19-X}, wherein 0≤x≤0.5.

The invention also relates to a hydrothermal method of making a cathode material of an alpha phase of copper vanadium oxide comprising preparing an aqueous solution of a copper oxide precursor and a vanadium oxide precursor, subjecting the aqueous solution to ultrasound, and heating the aqueous solution at a temperature of at most about 180° C., then filtering off the cathode material. Preferably, the cathode material is a solid. The hydrothermal method may further include (1) washing the cathode material with a solvent mixture; (2) washing the cathode material with a solvent mixture and drying the cathode material under vacuum; or (3) washing the cathode material with a solvent mixture, drying the cathode material, and ball milling the cathode material. The method may also further include assembling the cathode material into a coin cell.

### BRIEF DESCRIPTION OF THE DRAWINGS

FIG. 1(a) shows structure information of the present α-CVO solved by Rietveld Refinement (λ=0.7783 Å; dₘᵢₙ=0.84 Å) based on synchrotron powder XRD data; where α-CVO is synthesized by solid state reaction method. The refined atomic parameters and site occupancies for α-CVO are given in Table 1.

FIG. 1(b) shows present crystal structure of α-CVO.

FIG. 1(c) shows Li⁺ ion bond valence sum (BVS) difference map of present α-CuVO with valence difference (ΔV) of 0.08.

FIG. 1(d) shows Cu and V local coordinate information.

FIG. 2(a) shows voltage profile of pristine α-CVO (as-synthesized powder) during galvanostatic cycling (at C/35 rate).

FIG. 2(b) shows capacity retention for pristine α-CVO with cycling.

FIG. 2(c) shows voltage profile of α-CVO after 12 hours of ball milling during galvanostatic cycling (at C/35 rate).

FIG. 2(d) shows capacity retention of α-CVO after 12 hours of ball milling with cycling.

FIG. 2(e) shows SEM image of the pristine samples that were used for the galvanostatic cycling tests.

FIG. 2(f) shows SEM image of the samples after 12 hours of ball milling that were used for the galvanostatic cycling tests.

FIG. 3 shows X-ray diffraction patterns of α-CVO by solid state reaction method, in the pristine state (top), after 2 hours milling (middle), and after 12 hours of milling (bottom). Background contributions have been subtracted to allow a more direct comparison of peak intensities.

FIG. 4(a) shows SEM images and EDX maps of the Cu and V for present α-CVO synthesized by hydrothermal method.

FIG. 4(b) shows 1st, 2nd and 10th discharge and charge curves of present α-CVO synthesized by hydrothermal method.

FIG. 5(a) shows 1st, 2nd and 10th discharge and charge curves of present α-CVO, synthesized by solid state reaction and after 2 hours ball milling.

FIG. 5(b) shows cycling data of discharge (square)/charge (circle) for the present α-CVO (inset—Morphology information of α-CVO after 2 hours of ball milling.) The particle size of α-CVO (inset of FIG. 5(b)) may range from 200 nm to 1 μm which is smaller than pristine α-CVO (via solid state synthesis; FIG. 2 (e), which particle size may range from 5 μm to 50 μm). The structure of α-CVO is overall maintained after ball milling although structural disordering may occur with elongated milling time of 12 hours. (FIG. 3, XRD patterns of pristine α-CVO and α-CVO after 2 hours and 12 hours of ball milling)

FIG. 5(c) shows the discharge (square)/charge (circle) capacity of ca-CVO tested under a series of cycling rates (C/35, C/17.5, C/7, C/3.5 and C/1.75).

FIG. 5(d) shows galvanostatic intermittent titration technique (GITT) data for present α-CVO during its 1st cycle.

FIG. 6 shows capacity retention during discharge (square) and charge (circle) cycling as well as Coulombic efficiency (circle; top) of α-CVO, measured over 100 cycles at a rate of C/35. The α-CVO samples were synthesized by solid state reaction method and after 2 hours of ball milling.

FIG. 7 shows ex-situ XRD patterns measured from α-CVO at different discharge/charge states (as labeled) during cycling. The α-CVO sample was synthesized by solid state reaction method and after 2 hours of ball milling.

FIG. 8(a) shows 1st discharge curve of present α-CVO/Li coin cell tested at current density 20 mA/g (C/17.5) between OCV and 2.0 V, where α-CVO was synthesized by solid state reaction and ball milled for 2 hours.

FIG. 8(b) shows in-situ XRD data collected at present α-CVO/Li coin cell 1st discharge process where α-CVO was synthesized by solid state reaction and ball milled for 2 hours.

FIG. 8(c) shows the evolution of cell volume in the present α-CVO (dot) during 1st discharge step, where α-CVO was synthesized by solid state reaction and ball milling for 2 hours.

FIG. 8(d) shows the evolution of the amount of extruded copper atom from present α-CVO (dot) as a function of the amount of inserted lithium ions during 1st discharge process where α-CVO was synthesized by solid state reaction and ball milling for 2 hours.

FIG. 9(a) shows in-situ copper XAS data collected at different discharge/charge states (as labeled) during the first discharge process.

FIG. 9(b) shows in-situ XAS data collected at different discharge/charge states (as labeled) during the 1^{st} discharge process, where α-CVO was synthesized by solid state reaction and ball milling for 2 hours.

FIG. 10(a) shows first discharge and charge curves of present α-CVO/Li coin cell where α-CVO was synthesized by solid state reaction and ball milled for 2 hours.

FIG. 10(b) TXM image for α-CVO in the pristine state (left) and after discharge to 2.0V (vs. Li⁺/Li) (right) where α-CVO was synthesized by solid state reaction and ball milling for 2 hours. Image area is 40×40 m, collected with a 2048×2048-pixel detector.

FIG. 10(c) XANES spectra for α-CVO in the pristine state (left) and after discharge to 2.0V (vs. Li⁺/Li) (right), compared to the reference XANES spectra for Cu0 and Cu^{2+.} Herein, α-CVO was synthesized by solid state reaction and ball milling for 2 hours.

### DETAILED DESCRIPTION

The present α-phase of Cu—V—O may have a crystal structure in space group R-3 (No. 148) and lattice parameters of a=12.8560 Å and c=7.1939 Å when x=0.1. The present α-CVO may be used as a cathode material and may have a stoichiometry of about Cu_{6.90}V₆O₁₉, i.e. Cu₇₋ₓV₆O_{19-X}, wherein 0≤x≤0.5. Both Cu and V may access multiple valence states during cycling, 2+ and 1+ and 0+ for Cu and 5+ and 4+ for V. The α-CVO structure may have a cluster structure that allows it to exchange ions (such as Li) during electrochemical cycling without irreversibly destroying its framework. The specific gravimetric capacity of α-CVO may be 350 mAh/g, giving a theoretical energy density of approximately 350 mAh/g·2.6=910 Wh/kg (based on displacement reaction), and even higher theoretical values of 549 mAh/g or 549 mAh/g·2.6=1400 Wh/kg (based on combined displacement and intercalation reaction mechanism), which may be 2-4 times higher than the prior art cathodes (such as LiCoO₂˜140 mAh/g, or LiFePO₄˜169 mAh/g).

In an embodiment an energy density of the present cathode material may be up to 850 Wh/kg, a specific capacity and may be of up to at least 350 mAh/g with working potentials (above 2.4V). The present methods may be utilized to prepare cathodes of copper vanadium oxide (α-CVO) by either (1) a solid state reaction process, or (2) a hydrothermal method. Copper vanadium oxide (α-CVO) may be used as a rechargeable cathode in lithium ion batteries. These cathodes therefore may not be used only in primary batteries.

With the present α-CVO, high capacity (high capacity meaning for example multiple-electron transfers per formula) and 3D lithium diffusion channels may lead to an improvement in rate capacity. Two (2) electrons may be transferred from the Cu displacement reaction (electrochemical window 2.0 V to 3.6 V) and one (1) more electron may be contributed from vanadium in an enlarged electrochemical window of 1.0 V to 4.5 V. The vanadium redox reaction may occur if the discharge voltage is lowered down to 1.0 V. Vanadium is also an active element which may contribute to electrochemical performance. Below 2.0 V, vanadium may be reduced from +4 to +3 as may be shown by an in-situ XAS test. In the higher voltage region, for example above 3.6 V, the valence of vanadium may change from +4 to +5, where the valence change in the high voltage window may be deduced from the electrochemical curve.

The present α-CVO may have “wide” open channels for Cu-ion and Li-ion transport, where vanadium ions are clusters that are separated from each other by intervening Cu and/or Li ions, which facilitates fast ionic transport in the ceramic matrix during electrochemical cycling. Because of the open channels, the α-CVO exhibit high rate capability (or high power density): for example, 92% of the maximum specific discharge capacity was retained with a doubling of the current density (from C/35 to C/17.5), and about ⅔ was still accessible even at high rate of C/1.75, corresponding to 220 mAh/g.

The batteries with the present α-CVO may have a discharge capacity of at least 250 mAh/g after 20 cycles. The batteries may have a discharge capacity of at least 289 mAh/g after 20 cycles.

### Solid State Reaction

In an embodiment, the present α-CVO may be prepared by a solid-state reaction route. With the present solid state synthesis, α-CVO may be produced at low temperatures (e.g., 495° C. or lower) providing a lower cost method of synthesis compared to traditional methods which require high heat followed by extensive cooling steps. The solid state synthesized α-CVO materials may be a powder. The solid state synthesis may be carried out with precursors of Cu₂O and V₂O₅. The precursors may be ground by mechanical ball milling for a first round. The ground precursors may be collected from the ball mill for further processing. The conditions for the mechanical ball milling may be determined by a skilled practitioner. For example, the precursors may be subject to ball milling for about 20 minutes, 30 minutes, or 40 minutes at a rotational speed of about 250 rpm, 300 rpm, or 350 rpm. The ground precursors may form a powder mixture. The powder mixture may be mechanically pressed for a first round into a first solid pellet. For example, the pressed first pellet may be heated under inert gas at a temperature of at least about 250° C. for about 6 hours, 8 hours, or 10 hours, and then cooled down to room temperature. The solid state synthesized first powder or pellet may be micron-sized particles. The first pellet or powder may be pristine α-CVO. For example, after pre-heating at 250° C. (or higher), α-CVO may be formed and there may be precursor residue. A post-processing procedure for particle size reduction of the pristine α-CVO may be employed.

In one example, a second round of grinding of the first pellet or powder may be carried out for about 10 minutes, 20 minutes, 30 minutes, or 40 minutes followed by a second round of mechanically pressing into a second solid pellet. The second pellet may be heated under inert gas to a temperature of at most about 495° C. for about 6 hours, 8 hours, or 10 hours and then cooled down to room temperature. Finally, the cooled second pellet may be subjected to a third round of ball milling for about 2 hours. The second pellet may be assembled into a coin cell.

The purpose of grinding, pressing, and heating the mixture multiple times is to ensure that the mixture becomes as homogeneous as possible. The components tend to segregate during heating and require more than one round involving grinding, pressing, and heating. Preferably, two or three rounds may be required to ensure the cathode material is uniform. Furthermore, after the first round of grinding, the particles may be micro-sized. After the second round of ball milling, the particles may be nano-sized.

In general, mechanical ball milling may be used on the solid state synthesized powder. The ball milling time may be in intervals of about 2 hours, with crystallinity maintained and a particle size of a few hundred nm.

The present α-CVO cathode may involve the displacement of Cu²⁺ and Cu⁺ ions from the α-CVO structure that may lead to the formation of Cu metal. The reversible capacity (350 mAh/g (twice of prior art cathodes) in the window of 2.0-3.6V and >500 mAh/g in the window of 1.0-4.5V, may be found with present α-CVO cathodes. This performance may be due to an open framework that may accommodate multiple electron redox reactions.

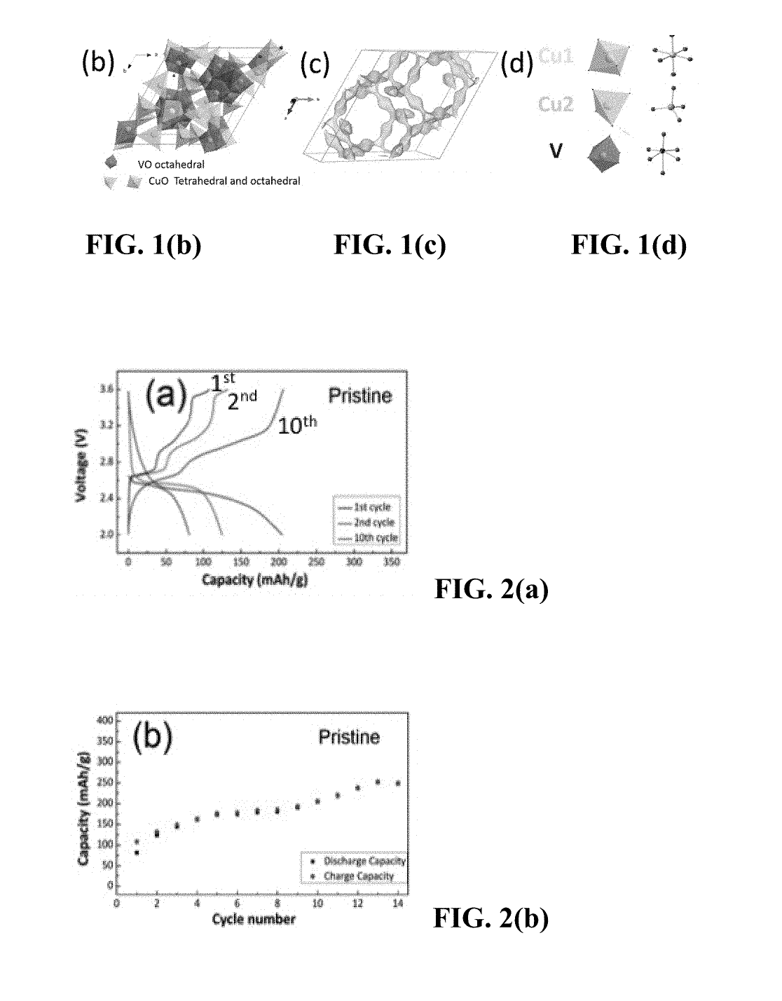

For the pristine α-CVO as prepared by solid-state reaction, its 1st discharge capacity is 82 mAh/g while it delivers 200 mAh/g at its 10th cycle (FIG. 2(a)). The increase of the capacity with cycling may be due to the cracking during cycling since the initial size of the pristine α-CVO is large, 10-50 m (shown by SEM in FIG. 2(e)). In the electrochemical performance data of a prepared α-CVO/Li (FIG. 2(a), the profiles for the 1st, 2nd and 10th cycles are given and labeled.

For α-CVO after 12 hours ball milling, its 1st discharge capacity is 241 mAh/g while it delivers 202 mAh/g at its 20th cycle (FIG. 2(d)). The relative low capacity after 12 hours compared to α-CVO after 2 hours ball milling could be attributed to high specific surface introducing some side reaction with electrolyte which hampers its electrochemical performance. The morphology information and electrochemical performance of α-CVO under 12 hours of ball milling is shown in FIG. 2(f). And the corresponding electrochemical performance data of a prepared α-CVO/Li coin cell cycled between 2.0V to 3.6V is shown in (FIG. 2(c)). The labeled lines show the 1st, 2nd and 10th cycles respectively.

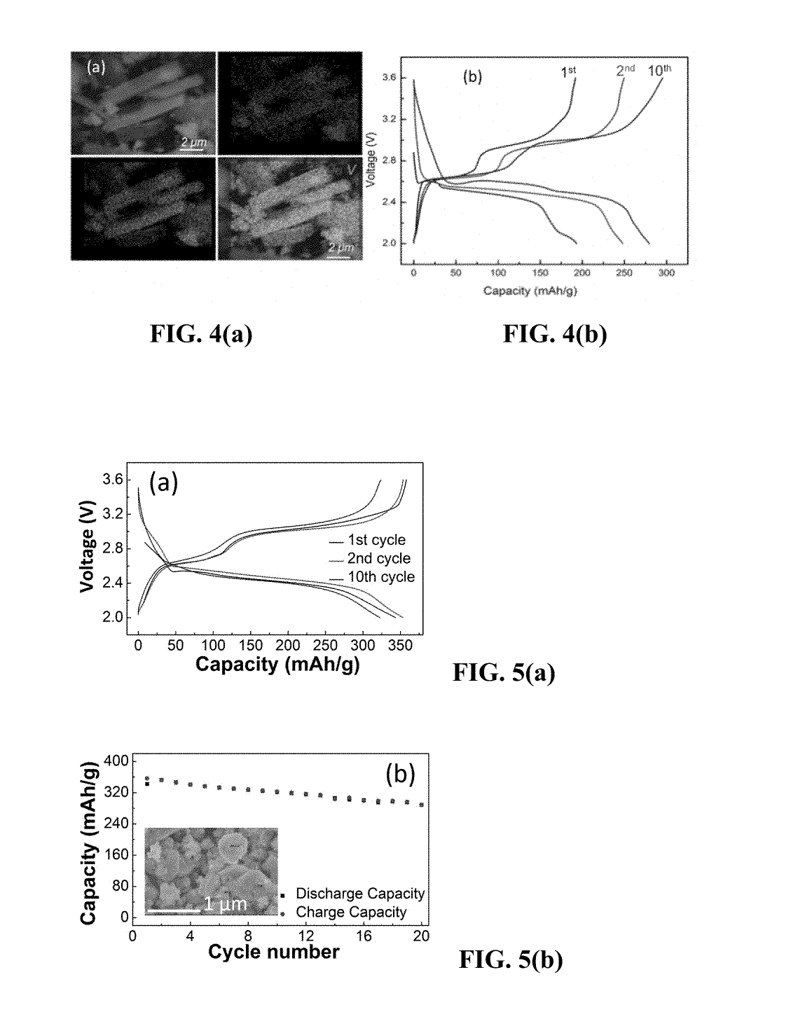

The discharge capacity of α-CVO after two hours of ball milling is 342 mAh/g, 352 mAh/g and 321 mAh/g in its 1st, 2nd and 10th cycle respectively (FIG. 5(a)). After 20 cycles, its discharge capacity is 289 mAh/g (FIG. 5(b)). The capacity retention after 20 cycles is 84.5%. The present α-CVO exhibits a rate capability, of 92% capacity retention, with a doubling of the current density (from C/35 to C/17.5), and 269 mAh/g at rate of C/1.75 (FIG. 5(c)). In the discharge step, combined with the GITT data shown in FIG. 5(d), it presents one plateau at 2.6V, while in the charge process, two plateaus (around 2.6 V and 2.9 V) are observed. The improved electrochemical performance of α-CVO could be attributed to its smaller particle size and high conductivity of Cu and Li ions in the 3D open channels of the framework.

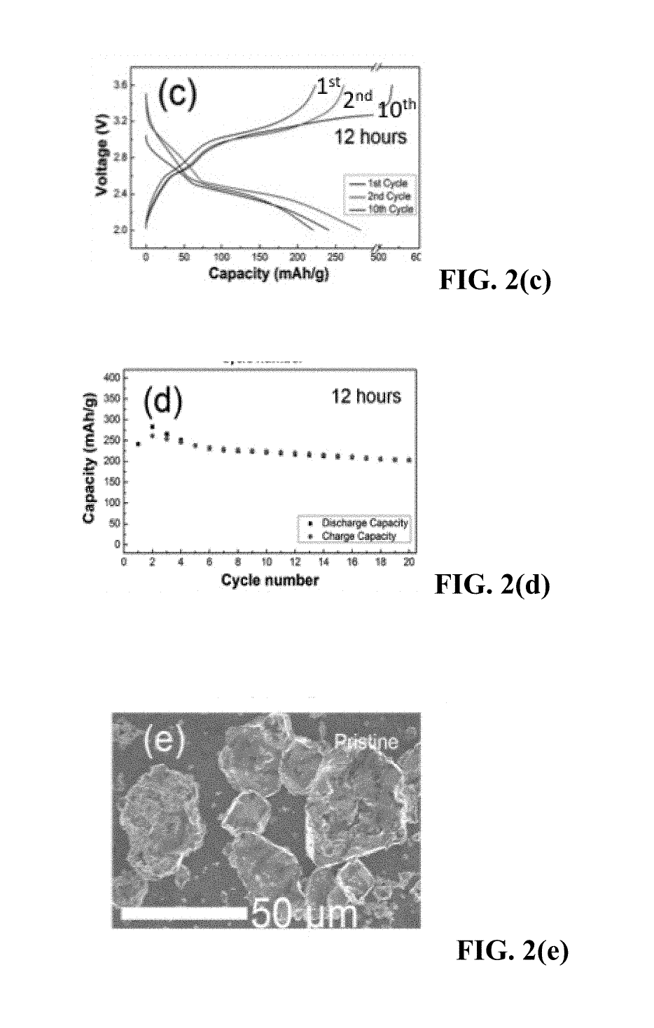

The particle size of α-CVO (inset of FIG. 5(b)) ranges from 200 nm to 1 m which is smaller than as-synthesized α-CVO (FIG. 2(e), particle size ranges from 5 μm to 50 μm). The structure of α-CVO may be maintained after ball milling although there is structural disordering in the α-CVO after 12 hours of ball milling (FIG. 3. XRD pattern of pristine α-CVO, and α-CVO after 2 hours and 12 hours of ball milling).

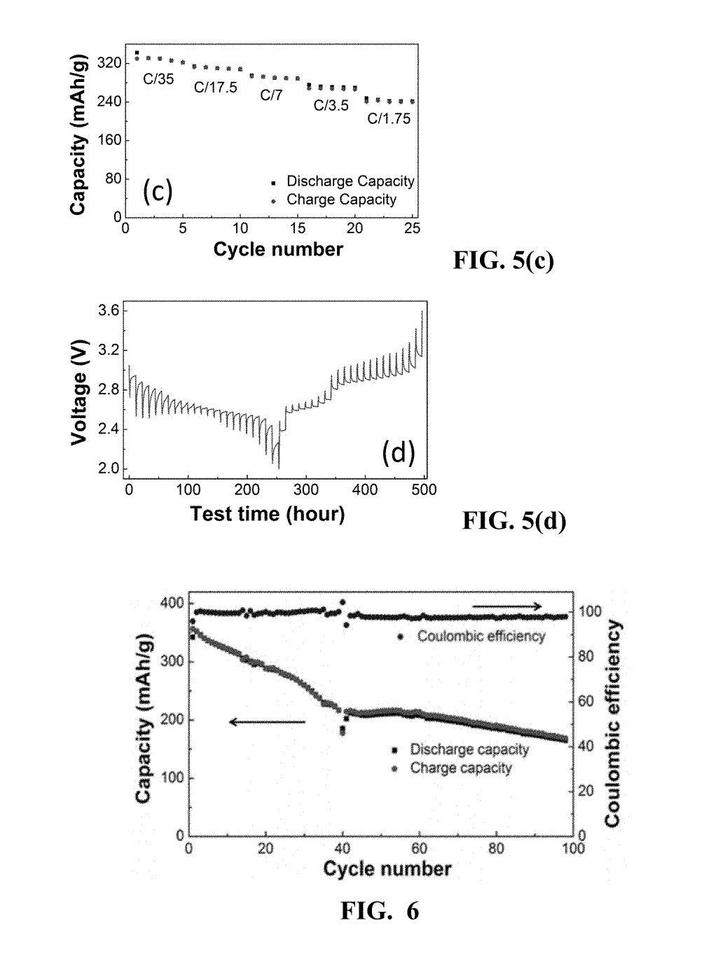

The α-CVO after two (2) hours of ball milling exhibits long cycling stability and high Coulombic efficiency (FIG. 6). Even after 40 cycles, discharge capacity>200 mAh/g may still be maintained, and the capacity decay may be slowed down afterwards, ending with ˜50% capacity retention by 100^{th} cycle; throughout the long cycling process, the Coulombic efficiency remained between 97.5 and 99.5%. This demonstrates an improved reversible behavior for a displacement reaction in which Cu metal is extruded from and then re-incorporated into a ceramic matrix (as examined by structural analysis using XRD).

### Hydrothermal Reaction

In an embodiment, the present alpha copper vanadium oxide may be synthesized by hydrothermal reaction method which may be carried out at a low temperature (e.g., 180° C. or below or at most 180° C.), and may be solution based, energy efficient and low in cost. The hydrothermal synthesis may be characterized by the following reaction.

Cu(NO)₃.2H₂O+NH₄VO₃→α-CVO (1)

Cu(NO)₃.2H₂O+NH₄VO₃ may be dissolved into distilled water, with 0.2204 g Cu(NO)₃.2H₂O and 0.1538 g NH₄VO₃ in 96 ml, and subjected to ultrasound for 30 minutes. The mixture (solution) may be transferred into a Teflon vessel and sealed into autoclaves. The autoclave (containing the mixture) may be placed into an oven and heated to a temperature of at most 180° C. for about 48 hours. A solid cathode material product may be filtered after the autoclaving and cooled down. The cathode material may be washed. The cathode material may be washed with a solvent followed by water. The solvent may be ethanol or acetone. The cathode material may be washed with ethanol, followed by distilled water and then acetone. After washing, the cathode material may be dried using a vacuum oven. Next, the cathode material may be manually ground or milled. The cathode material may be assembled into a coin cell.

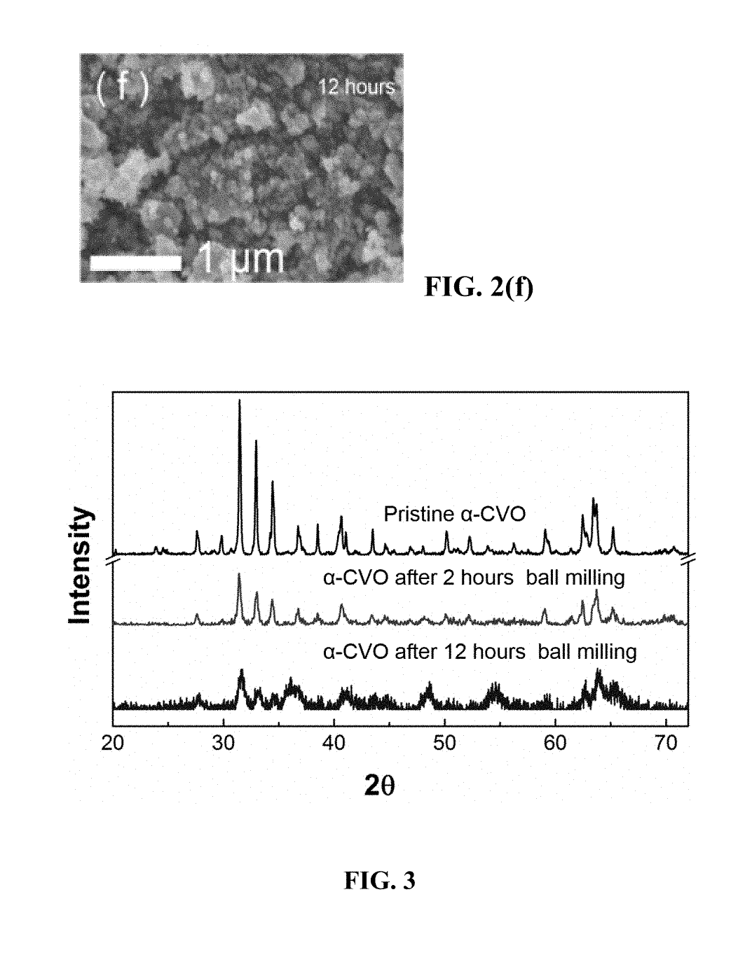

The α-CVO synthesized by hydrothermal reaction method may exhibit around 260 mAh/g capacity (FIG. 4(b)), which may be around twice than prior art cathodes, e.g., LiCoO₂ and LiFePO₄. Its energy density may be 260 mAh/g*2.6 to 676 Wh/kg, which may be larger than prior art cathode materials.

To achieve the present cathode material, crystal structure information may be analyzed based on a crystal structure database, such as the Inorganic Crystal Structure Database (ISCD): https://icsd.fiz-karlsruhe.de. A structure may be selected which has open channels for lithium ion. A connected and flexible structure may be desired to support the reversibility during the cycles. Material having an isolated or firm framework may be deselected as a candidate for the present cathode material.

One may vary the synthesis to increase yield and shape control in hydrothermal synthesis (as demonstrated in FIG. 4(a)), and identify desired elements to substitute into copper vanadium oxide and achieve desired electrochemical performance.

### Examples

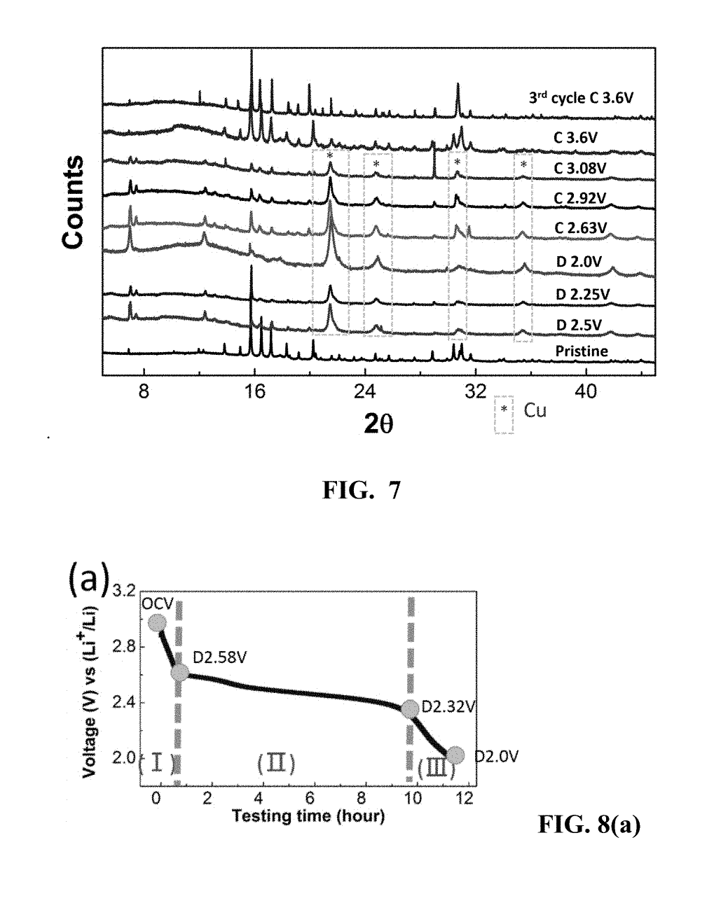

Ex-situ XRD studies (FIG. 7) were conducted to observe the structure changes in α-CVO (prepared by solid state reaction and after 2 hours of ball milling) during the discharge process. Upon discharge to 2.5 V, diffraction peaks associated with Cu metal appears, and gradually grows in intensity as the voltage is lowered. During the subsequent charge, the intensity of the Cu metal peaks continually decreases and can no longer be resolved at the end of charge. This may indicate that the displacement mechanism dominantly contributes to the electrochemical capacity of α-CVO although the peaks of the α-CVO phase are reduced in intensity during discharge, the sharp and intense peaks of this phase are recovered at the end of charging, even beyond the first cycle. From this, it can be concluded that the Cu displacement mechanism of α-CVO is reversible, unlike other displacement electrodes. This may be facilitated by the structure of α-CVO, wherein the isolated V₆O₁₈ clusters that are not connected by covalent bonds, may give the compound a flexibility and ability to accommodate the insertion and removal of mobile cations.

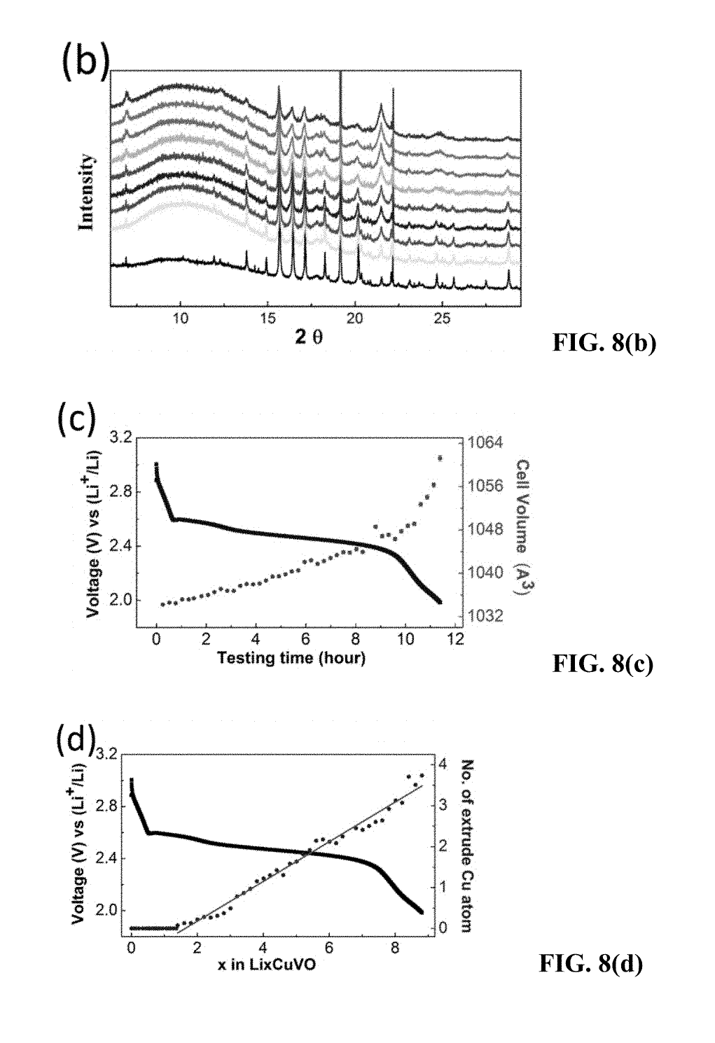

In-situ XRD studies (FIGS. 8(a)-(d)) were conducted to observe the structural changes in α-CVO prepared by solid state reaction and after 2 hours of ball milling during the discharge process. The 1st discharge curve tested with current density 20 mA/g is shown in FIG. 8(a). Related in-situ XRD data are shown in FIG. 8(b). Three peaks of α-CVO (131, 122, and 04-1) and one peak of copper (111) are chosen as representatives to show the structure evolution during the 1st discharge process. Initially, the XRD pattern of pure α-CVO shows a certain peak intensity. The peaks become broader and peak intensity becomes weaker during the discharge process. The peak positions of the α-CVO phase shift to the left during the discharge process and may be attributed to an increased spacing.

A combination of a LeBail fit for the α-CVO with a Rietveld fit of the Cu phase was used to quantitatively track the change in lattice parameters of the α-CVO phase during discharge process. Based on the fitting result, the unit cell volume of α-CVO increases during the discharge process. One copper atom extrudes from the matrix and leaves one site vacancy for one inserted lithium ion. This may be facilitated by the similar size of the copper and the lithium ions. The ionic radii of Cu²⁺, Cu⁺ and Li⁺ are 0.73 nm, 0.77 nm and 0.76 nm respectively. Because the radius of lithium ion is a little larger than Cu²⁺, the unit cell volume may increase gradually while a first lithium ion may occupy spare space in the crystal lattice. Due to the limited open space in one unit cell, the unit cell may expand to accommodate the squeezed second lithium ion during the discharge process. This step shows low kinetics due to the large polarization shown in GITT data. (FIG. 5(d)). Therefore, two different unit cell volume increase trends are observed in FIG. 8(c).

Additionally, the copper (111) peak area increases during its 1st discharge process. The amount of inserted lithium ions in the matrix is plotted as a function of the amount of copper atoms extruded from the matrix in FIG. 8(d). The number of extruded copper atoms with the inserted number of Li⁺ ions (x) over the entire composition range show two different slope areas. The first region is from OCV to discharge to 2.58 V. In this range, it is a lithium intercalation reaction. Lithium ion may fill in the vacant site of this structure and copper may not extrude from the matrix (slope region in FIG. 8(d)). The second region (one plateau and one steep line observed) is from discharge 2.58 V to discharge 2.0 V. The slope of the function between the amount of extruded copper and inserted lithium ion is 0.48 in this region, which may mean the reaction ratio between Cu and Li is 1:2 within the errors of calculation and experiments. This seems to indicate that the Cu²⁺ atoms take part in this electrochemical reaction. In this discharge step, the structure goes through a copper displacement reaction mechanism.

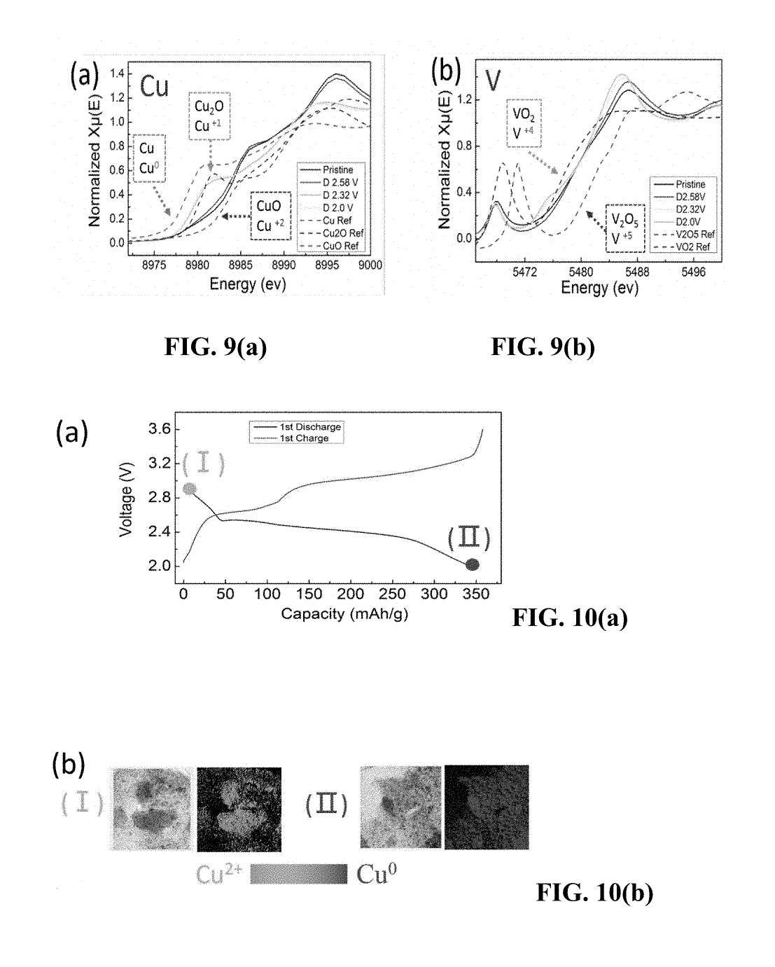

For in-situ XAS data shown in FIG. 9(a), copper valence moves from +2 towards 0 in its 1st discharge process which may mean copper goes through a reduction reaction. Vanadium valence stays constant which may mean it does not participate in the reaction during the 1st discharge step (FIG. 9(b)). Vanadium may not take part in the electrochemical reaction, but instead may function in a role as scaffold. This may benefit the structure stability and reversibility.

As previously stated, in prior studies of the α-CVO compound, vanadium may go through a reduction reaction during the discharge step. As a result, the vanadium may go through a change in its coordination environment. The stability of the structure may be hard to maintain if the vanadium oxide coordination polyhedron changes. However, in the present compound, the stability of the VO polyhedron may be preserved by the unchanging valence of vanadium during the discharge step if testing electrochemical window is from 2.0 V to 3.6 V. The V—O octahedral clusters may maintain a framework for α-CVO in this electrochemical potential window which may be beneficial to structure reversibility during electrochemical cycling. Although these clusters are not linked to each other through chemical bonds, they may still create a structural scaffold that may maintain structure reversibility during the electrochemical reaction. The mobility of clusters may be less than a single VO₆ octahedron due to their heavier mass.

The reaction mechanism of α-CVO during its 1st discharge process is studied by combination analysis of GITT data, in-situ XRD and in-situ XAS characterization. The mechanisms of the lithium reaction are identified in four (4) regions of α-CVO during the 1st discharge. The first region is from OCV to discharge at 2.58V, where a line with a steep slope is observed. According to the GITT data (FIG. 5 (d)) large polarization can be seen and may indicate low reaction kinetics in this range. The inserted lithium ions fill in the vacancy of Cu site. Based on the in-situ XAS data shown in FIGS. 9 (a)-(b), the valence of copper shifts to a lower value while vanadium valance remains constant. Lithium insertion is associated with the reduction of Cu²⁺, but Cu metal is not extruded during this process (FIG. 8 (d)). Therefore, this may be a lithium intercalation combined with a copper reduction reaction. A small capacity is found for Region I (voltages above 2.58V), during which lithium ions insert into the α-CVO structure causing the reduction of Cu cations. According to the GITT data (FIG. 5 (d)) large polarization can be seen and may indicate low reaction kinetics in this range. In this Region I from OCV to discharge at 2.58V, a line with steep slope is observed.

The majority of the capacity may occur in Region II (2.58-2.32V) during which lithium ions may insert into the structure accompanied by Cu extrusion due to the displacement of Cu²⁺ in a 2-electron process. For Region II, a plateau which may contribute large capacity may be observed. This may be a Cu²⁺ displacement reaction mechanism. (FIGS. 8(b) and 8(d)). According to the GITT data (FIG. 5(d)) in this range small polarization can be seen and may indicate that the reaction at this point has desired kinetics. This could be attributed to the lithium ion first introduced into the matrix.

A modest additional capacity may be found in Region III (2.32-2.0 V), during which Cu⁺ displacement chemistry may continue to occur but for which Li⁺ may be forced to insert into substantially less favorable interstitial sites. Further discharge may occur to 2.0V, after a majority of Cu²⁺ takes part previously in the reaction. Some Cu ions may go through the electrochemical reaction and contribute to capacity. The valence of copper may shift to a low value while the valence of vanadium may remain the same in the second and third regions (FIG. 8). As seen by the GITT data (FIG. 5(d)) in this range large polarization may be observed. This could be attributed to the second introduction of lithium ion into the matrix where kinetics may be relatively slow compared to the second region.

Region III processes may or may not be complete before V⁴⁺ reduction begins to occur at very low voltages (2.0-1.0V). The chemical reaction schemes associated with these regions can be summarized as:

Cu_{6.9}V₆O_{18.9}+xLi⁺+xe⁻→LiₓCu_{6.9}V₆O_{18.9}(0<x<0.1) (I)

LiₓCu_{6.9}V₆O_{18.9}+yLi⁺+ye⁻→Li_{x+y}Cu_{6.9-0.5·y}V₆O_{18.9}+0.5yCu(x>0.1;0<y<13.8) (II)

LiₓCu_{6.9}V₆O_{18.9}+zLi⁺+ze⁻→Li_{x+y+z}Cu_{6.9-0.5·y}V₆O_{18.9}+Cu(x>0.1;0<y<13.8;0<z<6) (III)

A specific capacity of 350 mAh/g can be achieved for α-CVO cathodes at an average discharge voltage of 2.42V, resulting in an overall energy density of 847 Wh/kg. This energy density is believed to be more than what would be delivered by a 4V cathode with a 200 mAh/g specific capacity. As such, it may exceed that of commercial intercalation cathode materials such as LiCoO₂ and LiFePO₄, and may be comparable to the performance being targeted in other Li-ion intercalation systems (such as for example, Li-excess layered compounds and high-voltage spinels). In situ measurements demonstrate that this capacity may be associated with Cu²⁺ displacement chemistry, though intercalation processes associated with the Cu²⁺/Cu⁺ redox couple occur at voltages above 2.6V and some intercalation associated with V⁴⁺/V³⁺ may occur at voltages below about 2.0V. In contrast to other systems that operate through similar displacement mechanisms, the displacement chemistry of the α-CVO phase is more reversible (with a low capacity fade over multiple charge/discharge cycles) and is compatible with relatively higher discharge rates. This enhanced reversibility may in part be attributed to the structural building blocks of isolated V₆O₁₈ clusters, which may enable the structural flexibility to accommodate the intercalation of excess Li ions utilizing atomic sites beyond those already occupied by mobile ions in the pristine compound.

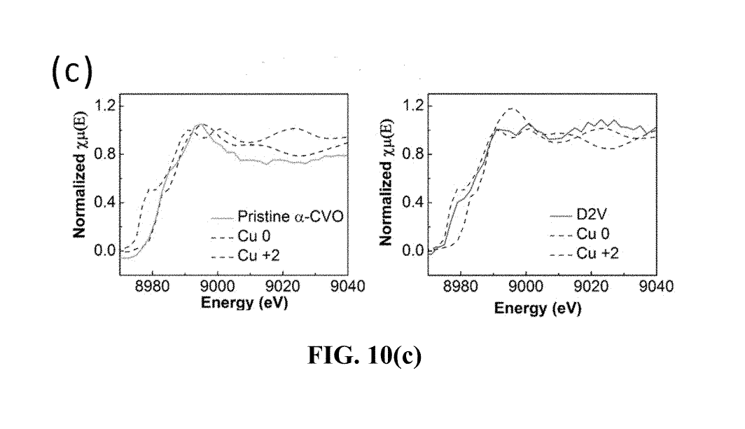

Transmission X-ray microscopy (TXM) is a non-destructive and chemical sensitive method which enables the study of correlation between the morphology and chemical phase mapping with sub-30 nm spatial resolution. First discharge and charge curves of α-CVO electrodes that were used for TXM and data schematic are shown in FIGS. 10(a) and (b) respectively. Cu presents +2 at OCV status according to ex-situ XAS spectrum of α-CuVO. Its edge overlaps with the edge of reference CuO. After the 1st discharge to 2.0V, the absorption edge of the sample is close to the reference Cu metal, and the large amount of copper metal is observed from the TXM chemical map FIG. 10(b), which is also confirmed by the ex-situ XRD (FIG. 7).

According to the fitting map result, an extruded copper map presents a homogenous dispersion, which indicates that the extruded copper did not agglomerate into big particles accumulated in a certain area. After the charge process, copper metal would insert into α-CVO matrix reversely, as shown in FIGS. (10(a)-(c). Small particle size and homogenous copper dispersion is supportive for copper insertion back, which contributes to improved cycling reversibility.

### Example—Synthesis—Solid State Reaction

A stoichiometric amount of Cu₂O and V₂O₅ as precursors are mixed and milled for 30 minutes in a planetary ball mill device (Gilson, model LC-106A) with a rotational speed of 300 rpm. Then, the mixture is pressed into a pellet and sintered by heating at 250° C. for several hours under inert atmosphere. Precursors are cooled to room temperature. Then they are ground 30 minutes and heated a second time at a higher temperature of 495° C. under inert atmosphere for several hours. Precursors are cooled to room temperature. Procedures are carried out in ambient atmosphere and the raw materials are analytical reagents used without any further purification or treatment.

### Example—X-Ray Diffraction (XRD)—Lab XRD

Powder X-ray diffraction data were collected at room temperature with a Bruker D8 Advance diffractometer with Bragg-Brentano geometry using copper Kα as a radiation source (Kα1=1.54053 Å, Kα2=1.54431 Å). It was equipped with a 1D position sensitive Lynx-Eye liner strip detector with 192 channels and 300 mm was used as the primary radius and secondary radius. Zero background silicon slides were used as sample holders. Routine pattern indexing and phase identification was done by using JADE software package. TOPAS software package (Bruker AXS, version 4.2) was used for Le Bail fitting and Rietveld refinement.

### Example—X-Ray Diffraction (XRD)—Synchrotron XRD

Synchrotron X-ray diffraction data for α-CVO samples were collected at beam line X14A at the National Synchrotron Light Source (NSLS), Brookhaven National Laboratory (BNL). The wavelength used in X14A was approximately 0.7783 A. It was equipped with a 1D linear position sensitive silicon strip detector with 640 channels. Data were collected over the 20 degree range of 4-54° (pristine powder) or 4-40° (in-situ and ex-situ electrode) with a counting time of 15 seconds per step.

Ex-situ electrode XRD (FIG. 7) diffraction data were collected to get the structure information at a specific discharge or charge stage. For ex-situ sample preparation, the coin cell was disassembled in an Argon filled glove box. The electrode was taken out from the disassembled coin cell and washed by DMC (dimethyl carbonate) to remove the possible deposited lithium salt on the surface. Then it was scraped out from the collector and sealed with Kapton film.

Compared to the ex-situ technique, in-situ analysis method may maintain the real reaction environment inside the coin cell. It may provide more accurate information to track the crystal structure change and phase transition during electrochemical processing, and may be a powerful technique to study the cathode reaction behavior in real time. For the in-situ coin cell test, a LaB₆ calibration may be performed before running the experiment in order to determine the angle position. A pristine spectrum may be collected at room temperature before current is applied to the coin cell. Synchrotron X-ray diffraction data for as-synthesized α-CVO may be collected at room temperature.

### Example—X-Ray Absorption Spectroscopy (XAS)

X-ray absorption spectroscopy (XAS) data for copper and vanadium at their own K-edge are collected at beam line X18A of National Synchrotron Light Source (NSLS), Brookhaven National Laboratory (BNL).

In-situ electrode XAS data were collected to get the copper and vanadium valence information at specific discharge or charge stages. The XAS data were collected at room temperature by using a Si (111) double crystal monochromator in a transmission mode with an operating voltage set at 2.8 GeV and a typical current of 300 mA. Harmonics were rejected by detuning. Copper or vanadium foil was used simultaneously as references for energy calibration. X-ray absorption near edge structure (XANES) spectra were taken every 0.5 eV up to 50 eV after the edge with an integration time of 2 s. Based on the experimental setup, a 1 mm slit size was used and the beam experimental resolution was 1.7 eV. Synchrotron X-ray absorption data for as-synthesized α-CVO were collected at room temperature. X-ray absorption near edge structure (XANES) data were processed using the ATHENA software package.

### Example—Cathode Fabrication and Electrochemical Measurement

To evaluate electrochemical performance, composite electrodes were constructed by mixing the active materials, super P and Polyvinylidene difluoride (PVDF) in the weight ratio of 70:20:10. Proper amounts of 1-methyl-2-pyrrolidinone (NMP) were added into the mixture and a slurry was formed. Then the slurry was coated on the aluminum foil with the thickness of 25 μm. The diameter of the punched cathode was 10 mm. Typical loading of the active material was 2-3 mg. The cathode was dried under vacuum at 100° C. for several hours. The test cell was assembled in an argon filled glove box with lithium metal as an anode, a Celgard 2300 sheet as separator and 1 M LiPF₆ in a mixed ethylene carbonate (EC)/dimethyl carbonate (DMC) (1:1 in volume) solution as an electrolyte. The charge-discharge measurements were carried out in a potential range from 2V to 3.6V (vs. Li+/Li) using an Arbin Cycler. 2025 coin cells were assembled, cycled and tested at room temperature.

### Example—Structure Information

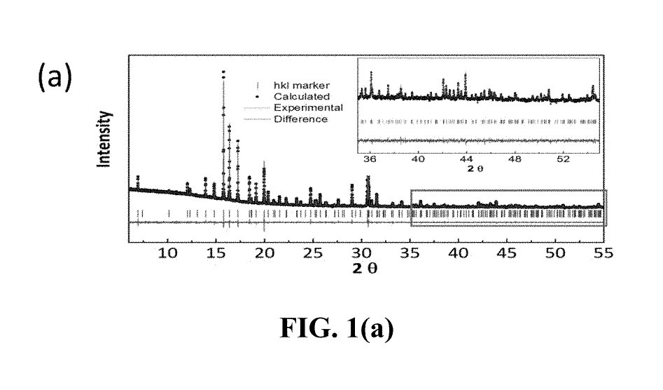

Structure information of the present solid state synthesized α-CuVO is solved by Rietveld Refinement result based on synchrotron powder XRD data (FIG. 1 (a) and Table 1). All the peaks could be indexed to α-CVO phase with an R-3 space group (space group number 148, PDF file number: 72-1527 from ISCD: https://icsd.fiz-karlsruhe.de) and no other peak is observed, indicating a pure phase. The refined lattice parameters of present synthesized α-CVO are a=12.8547 Å, c=7.1936 Å which is compatible with literature reported. The stoichiometry refines to Cu_{6.903}V₆O₁₉. Two copper sites, one vanadium site and four oxygen sites exist in this lattice structure (atom information is provided in Table 1). The partially occupied Cu1 site contains Cu in an octahedral coordination environment, while the fully occupied Cu2 site is representative of Cu tetrahedrally coordinated to 4 oxygen atoms. Six vanadium oxide octahedra form clusters that are isolated from each other. (FIGS. 1(b) and 1(d)). A 3D Li-ion diffusion channel is predicted by Li+ ion bond valence sum (BVS) difference map calculations for α-CVO with a valence difference (ΔV) of 0.08. (FIG. 1(c)).

TABLE 1
Refined atomic parameters and site occupancies for α-CVO,
as-synthesized by solid state reaction method.

| Atom | Wyck. | x | y | Z | Occ. | Bᵢₛₒ (Å) | Valence |
|---|---|---|---|---|---|---|---|
| Cu1 | 3b | 0 | 0 | ½ | 0.901(7) | 0.1489(2) | 2.04 |
| Cu2 | 18f | 0.0961(1) | 0.3888(1) | 0.0683(2) | 1 | 0.1489(2) | 1.73 |
| V | 18f | 0.1356(7) | 0.1514(2) | 0.1727(1) | 1 | 0.4563(1) | 4.05 |
| O1 | 18f | 0.4355(6) | 0.0672(3) | 0.0157(5) | 1 | 0.2000 | |
| O2 | 18f | 0.1279(2) | 0.0206(7) | 0.3049(1) | 1 | 0.2000 | |
| O3 | 18f | 0.0900(2) | 0.2359(9) | 0.0031(1) | 1 | 0.2000 | |
| O4 | 3a | 0 | 0 | 0 | 1 | 0.2000 | |

### Example—Scanning Electron Microscopy (SEM)

Morphological information was collected using a Hitachi 4800 scanning electron microscope with an operating voltage of 5 kV and working distance of 2.5 mm in under vacuum to minimize charging effects. SEM image and energy-dispersive X-ray spectroscopy (EDX) information were obtained by using JEOL 7600F with an operating voltage 10 kV and working distance of 7.5 mm. Powder samples were mounted on a circular aluminum standard plate sample holder using double sided carbon conductive tape.

### Example—Transmission X-Ray Microscopy (TXM)

The transmission X-ray microscopy method was used to collect sample morphology information and XAS data at beam line X8C, National Synchrotron Light Source (NSLS), Brookhaven National Laboratory. A field view of 40×40 m with a 2048×2048 CCD camera was used. To study the chemical state evolution, X-ray Absorption Near Edge Structure (XANES) image series was measured by scanning Cu absorption K-edge from 8960 to 9040 eV, with a 2 eV step size, and one TXM image at one energy step, which generated 1 k×1 k XANES spectra with 2×2 binned pixels. Each image was collected with 10 s exposure time. 2×2 camera pixels were binned into one output image pixel. The chemical phase maps (fitting) were obtained by using the customized program (MatLab, Mathworks, R201 b) developed by X8C beamline at NSLS.

1. A lithium ion battery comprising a cathode comprising an α-copper vanadium oxide having a stoichiometry of Cu₇₋ₓV₆O_{19-X}, wherein 0≤x≤0.5, and the discharge capacity is at least 250 mAh/g after 20 cycles.

2. The lithium ion battery of claim 1, wherein the discharge capacity is at least 289 mAh/g after 20 cycles.

3. The lithium ion battery of claim 1, further comprising an energy density of between 650 and 850 Wh/kg.

4. The lithium ion battery of claim 1, further comprising an energy density of up to about 850 Wh/kg.

5. The lithium ion battery of claim 1, wherein the copper vanadium oxide has open channels for lithium ion transfer during an electrochemical cycling process.

6. A solid state method of making a cathode material of an alpha phase of copper vanadium oxide comprising grinding a copper oxide precursor and a vanadium oxide precursor to form a powder mixture, pressing the powder mixture to form a first pellet, and heating the first pellet under inert gas at a temperature of at least about 250° C., cooling the first pellet to room temperature, ball milling the first pellet to form a milled pellet, pressing the milled pellet to form a second pellet, heating the second pellet under inert gas at a temperature of at most about 495° C., and cooling the solid pellet to room temperature to form the cathode material.

7. The solid state method of claim 6, wherein the copper oxide precursor is Cu₂O and the vanadium oxide precursor is V₂O₅.

8. The solid state method of claim 6, wherein the cathode material is a nanoparticle.

9. The solid state method of claim 6, wherein the inert gas is argon.

10. The solid state method of claim 6, further comprising assembling the cathode material into a coin cell.

11. The solid state method of claim 6, wherein the cathode material is Cu₇₋ₓV₆O_{19-X}, wherein 0≤x≤0.5

12. A hydrothermal method of making a cathode material of an alpha phase of copper vanadium oxide comprising preparing an aqueous solution of a copper oxide precursor and a vanadium oxide precursor, subjecting the aqueous solution to ultrasound, and heating the aqueous solution at a temperature of at most about 180° C., then filtering off the cathode material.

13. The hydrothermal method of claim 12, wherein the cathode material is a solid.

14. The hydrothermal method of claim 12, further comprising washing the cathode material with a solvent mixture.

15. The hydrothermal method of claim 12, further comprising washing the cathode material with a solvent mixture and drying the cathode material under vacuum.

16. The hydrothermal method of claim 12, further comprising washing the cathode material with a solvent mixture, drying the cathode material and ball milling the cathode material.

17. The hydrothermal method of claim 12, further comprising assembling the cathode material into a coin cell.
